(19) United States
(12) Patent Application Publication
(10) Pub. No.: US 2023/0280116 A1
(43) Pub. Date: Sep. 7, 2023

(54) DEEP DRAW HVAC COILS WITH BUILT-IN SELF-CLEANING MECHANISM AND METHOD OF TREATING DEEP HVAC COILS

(71) Applicant: BLUE BOX AIR, LLC, Dallas, TX (US)

(72) Inventor: James METROPOULOS, Dallas, TX (US)

(21) Appl. No.: 18/117,341

(22) Filed: Mar. 3, 2023

Related U.S. Application Data
(60) Provisional application No. 63/316,573, filed on Mar. 4, 2022.

(51) Int. Cl. F28G 9/00; B08B 9/032

(52) U.S. Cl. CPC F28G 9/00; B08B 9/0325; B08B 2209/032

(57) ABSTRACT

Disclosed are devices and systems for self-cleaning deep HVAC coils with built-in self-cleaning mechanisms and enhanced heat transfer, and methods of cleaning thereof. For example, some embodiments of a deep HVAC coil include a series of built-in self-cleaning mechanisms disposed among an array of heat transfer coils. Depending on the size and depth of the deep HVAC coil, the number of self-cleaning mechanisms may vary. The disposition and installation of self-cleaning mechanisms in the deep coil HVAC is configured to provide an even distribution and injection of a desired cleaning solution or foam which sufficiently covers an internal surface area of the deep HVAC coils and sufficiently fills an internal volume of the deep HVAC coils.

### CROSS-REFERENCE TO RELATED APPLICATION

This application claims the benefit of U.S. Provisional Application No. 63/316,573, filed Mar. 4, 2022, which is incorporated by reference in its entirety.

### BACKGROUND

### Technical Field

This disclosure generally relates to HVAC systems. More specifically, the present disclosure relates to deep HVAC coil devices, systems and methods for cleaning thereof.

### Related Technology

Heating, ventilation, and air conditioning (HVAC) systems typically consume over 50% of a building's total energy. It is estimated that roughly half of this energy is wasted because the heat transfer coils in HVAC systems are operating in a fouled condition. Such fouled coils are the primary source of many operational problems found within HVAC systems, such as excessive equipment wear and tear, decreased human health due to poor indoor air quality, and excessive energy consumption. Hydrocarbon buildup from outside air pollution, pollen, dust, and grease are examples of common materials causing HVAC coil fouling. Another cause of fouling is the formation of bacteria and fungi deep inside the coils.

The design of all HVAC systems revolves around the heat transfer coil, contained inside an air handler, which lies at the core of how an HVAC system transfers and/or absorbs heat in order to deliver and maintain a climate-controlled environment. A climate-controlled environment is generally accomplished by circulating a refrigerant through heat transfer coils while moving air over the heat transfer coils to heat or cool the air so as to achieve a desired set temperature. The air molecules moving around the coils must be cooled down in a relatively short period of time because the velocity and speed at which the air molecules are moving is very high. The less time air spends circulating around heat transfer coils means more heat must be transferred (or absorbed) in any given moment to result in the desired set temperature, resulting in a greater consumption of energy.

Coil fouling not only reduces the operational efficiency of HVAC systems, but also dictates the depth and density of how coils and HVAC systems are designed. Generally, a large air handler will contain a relatively small surface area of heat transfer coils as most commercial HVAC systems are outfitted with 8-row and 12-row coils. The deepest coils a conventional system may have would be roughly 24-row coils but no system has coils deeper than this. For example, nearly all HVAC heat transfer coils are designed to have a total depth in a range of 2-18 inches, with the vast majority of these coils having a total depth of less than 12 inches (e.g., 2-6 inches in depth). The depth of the coils corresponds to the cooling path length (i.e., the length of the spaces through the coils, including spaces between adjacent plates or fins). A relatively shallow depth of the coils is a design specification driven by the tendency of coils to become fouled and plugged over time. If coils are designed too deep, then the coils will quickly plug up due to fouling, which will ruin the normal functioning of the heat transfer coil and lead to some of the problems identified above.

Because of the lack of an effective process to penetrate through and clean a coil, HVAC manufacturers standardized the design of heat transfer coils to be relatively shallow, seeking to increase the surface area of a coil and making the circulating refrigerant colder so that heat transfer occurs faster. For this reason, coils that are deeper than 6 inches typically have greater fin spacing to create larger volume pathways for air flow to reduce the effects of blockages. However, this also reduces the surface area, or contact area, between moving air and the fins, which reduces cooling efficiency and offset the additional cooling effect that a longer cooling pathway would otherwise provide.

The limitation of coil depth requires that heat transfer coils be designed to encompass much larger surface areas, greatly increasing the overall size of HVAC systems. In addition, the limitation on coil depth requires that the circulating refrigerants be kept at a much colder temperature range in order to transfer heat at much faster rates. The shallow coil design limitation further increases the energy consumption in order to maintain these colder circulating refrigerant temperatures.

The circulating refrigerant is typically a hydrofluorocarbon, such as R134 (tetrafluoroethane) or R22 (hydrochlorodifluormethane), as well as others known collectively as “freon”, and a centralized compressor acts as a pressurized pump that compresses then quickly expands these refrigerants, creating heating and cooling cycles. The refrigerant is typically circulated at 45° F. through the coils in order to achieve a 65° F. exit air temperature (i.e., to maintain a climate-controlled environment at 65° F.). It takes a tremendous amount of energy to operate the compressor to keep the refrigerants at a 45° F. temperature. In essence, modern HVAC systems use brute force to cool (or heat) the refrigerants, which is energy and carbon intensive, leading to higher building costs.

For any HVAC system, there are typically two heat transfer coils that the refrigerant passes through—the evaporator coil and the condensing coil. Inhibited air flow and heat transfer through either of these coils will adversely affect the performance, heat transfer, and overall energy efficiency of a HVAC system. For example, a fouled evaporator coil will greatly reduce how well the air can be heated or cooled within a defined space so as to deliver the optimal climate-controlled environment. When evaporator coils foul, an HVAC system often must work harder and consume more energy, but not deliver the same degree of heating or cooling that is desired. This can result in an HVAC system continuously running because the system is never able to meet its set temperature. This can also result in a system operating at a much lower chilled water setting, such as found in an air-cooled chilled water system, where a lower chilled water temperature would be employed to overcome fouling effects of a evaporator coil.

Additionally, when a condensing coil is fouled, this also has a negative impact on the overall HVAC performance. The drop in performance and efficiency occurs because foulants inhibit the ability of the coils to reject heat and reduces the ability of the coils to condense the circulating refrigerants so to achieve the optimal absorption of heat energy when these gases expand into the evaporator coil. The inability to quickly reject heat from the compressor prematurely wears down the working components of the compressor, reducing its overall useful life.

Biological fouling is exceptionally problematic for HVAC systems. When microbes take root deep inside the coils they begin to form biofilms, which is a plasticity-type membrane excreted by these microbes. Biofilms are particularly detrimental to the HVAC system because these films are highly conductive which works to further inhibit heat transfer between the metal surfaces of the coil and the passing air flow. In addition, biofilms can have sticky surfaces that can accumulate dust and the other fouling debris, thereby acting in a feedback loop to inhibit air flow and efficient heat transfer though the coils.

When bacteria and fungi take root deep inside HVAC coils, many other operational problems can arise outside of inhibited air flow and heat transfer. As colonies of these microbes grow, their biological activity begins to off-gas noxious odors, creating a common problem in HVAC referred to as “Dirty Socks Syndrome”—a condition where the air supply in a building begins to present with a foul smell of dirty socks or other types of unpleasant smell.

For hospitals, biological fouling of HVAC coils is especially problematic and can present a near epidemic level problem for the global health care system. In the last several years, hospitals have seen a frightening rise of antibiotic resistant bacteria, such as Staph, MRSA, and others, taking root within nearly all medical facilities. It is now becoming a relatively common occurrence for sick patients to come into a medical facility needing treatment for one condition and then becoming infected with an antibiotic resistant strain of another illness contracted while visiting the hospital. In spite of extensive and vigilant sanitizing and cleaning efforts, medical facilities have so far been unable to eliminate dangerous microbes from the medical facility's operating environment. A major reason for this inability to eradicate dangerous microbes is due to the ability of antibiotic resistant microbes to hide, thrive, and migrate through the medical facility via its HVAC system. Specifically, it is deep inside the coils where antibiotic resistant microbes have found safe refuge, and the HVAC system provides means for traveling throughout the medical facility.

Heat transfer coils of HVAC systems within large medical facilities can range in depth from 2 to 18 inches, typically 4 to 12 inches. Spacing between fins in the coils is extremely compact, with space measured in millimeters between each fin. The objective of the coils is to provide as much surface area as possible within a confined space, making the space between fins only large enough to permit air to pass through. In addition, the heat transfer coils in large facilities can often reach 15 feet in height and are sealed on top so that air can flow evenly through the coils. This means there is often no way to access the coils from the sides or top of the system. The density of the packed coils serves to inhibit liquids from traveling more than 2 inches inside the coils, which leaves the vast majority of internal coil surface area completely inaccessible for cleaning.

The result is that the internal surface area of HVAC cooling coils provides an ideal sanctuary for antibiotic resistant, and all other, bacteria and fungi to take root and thrive within a medical or other facility. Because the objective of the HVAC system is to circulate air throughout the facility, dangerous microbes can be carried in the air stream and efficiently spread throughout the facility. While a medical facility can be extremely vigilant in cleaning all exposed surface areas throughout the facility, the inability to sanitize and disinfect deep inside the coils leaves these facilities exposed and unable to fully mitigate dangerous risks posed by traveling microbes. In addition to this adverse effect on indoor air quality, fouled coils greatly reduce both air flow through and heat transfer by the coils, which reduces overall performance and efficiency of a facility's HVAC system.

One practice employed throughout the HVAC industry, hotels, hospitals and other facilities is to clean HVAC coils using pressure washers. Another practice is to inject highly caustic or acidic solutions into the coils via a pressure washer or a handheld pump spray device. Yet another practice is to inject steam into the coils. These practices are completely ineffective in penetrating completely through the coils, especially coils deeper than 6 inches. These processes are also ineffective in removing biofilms or in sanitizing and disinfecting deep internal surface areas of the coils. In addition, all of these processes require complete shutdown of the air handler in order to service and are often damaging, wasteful, and hazardous to the environment.

Pressure washing, by far the most commonly employed practice in cleaning HVAC coils, involves the use of high-pressure water of at least 50-100 psi, often exceeding 1,000 psi, to create a pressurized stream of water which is applied to the coil's outer surfaces. However, the dense packing of the coils acts to prevent water from penetrating more than about 2 inches into the coils, regardless of the injection of high-pressure water. The tightly packed coils absorb the energy and deflect the pressurized water stream. In addition, due to the weight of water and force of gravity, when the pressurized water stream loses kinetic energy due to absorption by the coils, the water naturally falls vertically towards the ground, resulting is less efficient cleaning.

Another weakness of pressure washing is that at 1,000+ psi (or even as low as 50-100 psi) the force of the pressurized water stream can quickly and easily bend the coil fins. The coils themselves are tightly packed and made from very thin soft metals, such as aluminum or copper. Once coils are bent and damaged in this manner, air flow is further restricted and made uneven, further reducing flow-through efficiency of the air handler.

In addition, pressure washers utilize enormous quantities of water. Pressure washers can consume from 6-20 gallons per minute depending on their size. At the smallest version of 6 gallons per minute, a 1-hour cleaning of coils can result in the consumption of 360 gallons of water. It is not uncommon to consume well over 1,000 gallons of water during the cleaning of one large air handler.

Another problem, recognized in U.S. Pat. No. 9,676,007, is that pressure washing can drive debris more firmly into the coils and fins, further exacerbating the problem rather than solving it. At higher pressures of 40 psi or more, 25 psi or more, 10 psi or more, or even 7 psi or more, detergent foams do not exist because the air in the foam collapses to form a spray of liquid or droplets. This is readily observed at car washes, where cleaning foam is applied at low pressure, while the rinse water is applied at high pressure, even though applying higher pressure foam, if possible, would be more effective at dislodging dirt. In addition, the compression of air and collapse of detergent foams at higher pressures greatly increases the concentration of water and reduces the concentration of air.

Another technique for cleaning coils involves the use of a handheld pump spray and the direct injection of a caustic or acidic coil cleaner. This process is typically performed at lower pressures compared to high pressure washers. The idea behind caustic coil cleaners is to remove biofilm buildup inside the coils. Unfortunately, biofilms can present a plasticity type of membrane that is impervious to caustic, acidic, and even oxidizing solutions. In addition, caustic solutions can actively react with, and strip layers of, metal molecules from the coil surfaces. This is highly damaging and often leads to complete destruction of the coils over relatively short periods of service time. Finally, the pump spray method of injecting a caustic solution into coils experiences the same physical issues of pressure washing where only the surface and perhaps a few inches in depth are actually penetrated.

Another technique used to clean coils involves injecting the coils with high temperature steam. In this process, high temperature steam is directly injected into the coils with the hopes that the steam will physically break down biofilm, bacteria, dirt and grime. However, steam injection faces similar physical barriers as pressure washing because the outer coil surfaces can absorb kinetic and heat energy of the injected steam and inhibit its penetration to only a few inches. In addition, while steam may kill some of the bacteria and fungi near the outer coil surfaces, high temperatures are typically ineffective in removing the actual biofilm layer. In addition, the use of high temperature steam in many physical locations within a facility is impractical and can set up fire systems due to its excessive heat.

### SUMMARY

The present disclosure is directed toward innovations in heating, ventilation and air conditioning (HVAC) heat transfer coil designs and systems. In some embodiments, the disclosed innovations apply to the evaporative and condensing coils within the HVAC system. Additionally disclosed are deep HVAC coils with built-in self-cleaning mechanisms and methods of use. Also disclosed are various methods for implementing a self-cleaning process, which processes may vary depending on the operating environment of the HVAC and the heat transfer coils. Disclosed methods may involve delivering combinations of water, surfactant, and enzymes, probiotics, among other potential cleaning agents, such as degreasers, disinfectants, and deodorizers to the deep HVAC coils.

In some embodiments, the deep HVAC coils have a built-in self-cleaning mechanism and enhanced heat transfer. For example, some embodiments of a deep HVAC coil include a series of self-cleaning mechanisms installed at a top of a housing frame, which emit foam or spray at spaced-apart locations along the length of the cooling path. Depending on the size and depth of the deep HVAC coil, the number of spaced-apart self-cleaning mechanisms may vary. The disposition and installation of self-cleaning mechanisms in the housing frame and/or throughout the deep HVAC coil is configured to provide an even distribution and injection of a desired cleaning solution or foam to sufficiently cover an internal surface area of the deep HVAC coils and sufficiently fill an internal volume of the deep HVAC coils. In some embodiments, the self-cleaning mechanisms includes a plurality of spaced-apart tubes of the coil configured with injection ports and/or perforations that emit cleaning foam or solution (e.g., an enzyme mist) to the heat exchange coils at various locations or intervals along the length of the cooling pathway.

Some methods of cleaning the coils may involve evenly injecting or emitting a pH-neutral enzyme, probiotic, or other cleaning agent formulation as a foam phase or mist spray into a top of the coils at spaced-apart intervals. The foam or mist may be emitted through self-cleaning mechanisms that, in some embodiments, may be fitted and at the top of a housing frame. The housing frame may include a mixing chamber, where the mixing chamber has an elevated space measuring approximately 3-5 centimeters in height and approximately 3-5 centimeters in width with a spacing that will extend the entire width of the coil. This mixing chamber may fill up with foam or liquid and then spread the foam or liquid (e.g., mist) evenly across the top of the exposed deep HVAC coils so that the foam or mist will then pressurize and be pushed evenly between the deep HVAC coils.

Prior to the injection or emission of the foam (e.g., enzyme and/or cleaning foam) or other cleaning solutions (e.g., fine enzyme, disinfectant, or deodorizer mist), a control system may first turn off the air blowers (also known as air handlers) of the HVAC system. The lack of airflow through the coils will allow the enzyme foam, and/or other cleaning solutions or mist, to flow vertically downward into the coils. After a predetermined injection or emission period, the air flow may then be reactivated, drawing air through the coils. This airflow will then cause the foam or other cleaning solution to migrate horizontally though the coils, ensuring near perfect surface area coverage through the coils, include fin surfaces.

As part of the cleaning process, once the chemical foam or solution (e.g., spray or mist) enters the targeted vessel (i.e., deep HVAC coil), it can proceed to fill the entire internal volume space. Once full, injection of new chemical foam or solution may be stopped or slowed and compressed air may be fed through the coils. Since there may be an open outlet that permits exit of foam or solution, the deep HVAC coils do not become pressurized; however, continuous injection of compressed air serves to generate mechanical agitation through the foam or solution filled coils. This mechanical agitation, combined with the chemical reactivity of the foam or solution, works to break down residues inside the coils. After a predetermined period of time, new foam can be injected or emitted into the vessel, pushing out any spent foam and removed dirt or debris, which creates a conveyor effect, whereby the loose particles of residues fall into the foam and are then carried out of the coils. The spent foam can be removed by known means, such as a drain and/or vacuum line.

When an aqueous chemical solution is converted into a chemical foam phase and then injected into a system, the foam is able to fill the entire vessel with a far lower volume of chemical solution than if the same task were attempted as an un-foamed liquid solution. The key advantage here is that a reduction of up to 90% less solution is needed when converted into a foam. Beneficially, a reduction in required solution also leads to a reduction in water use. In addition, when an air handler and/or deep HVAC coil system is filled with a chemical foam, its chemical reactivity can be greatly enhanced by the mechanical action of injecting compressed air, which has the benefit of helping the foam create friction as it moves and circulates throughout an air handler and/or deep HVAC coil system. In addition to these benefits of foam, another benefit is that foam is comprised primarily of extremely lightweight air, which means that it is possible to fill very large vessels with a chemical foam, that would otherwise be impossible using a normal aqueous solution due to weight and volume limitations.

The present disclosure lays out a method and system for using enzymatic, probiotic, chemical, or any other cleaning solution product delivered by a foam generating system that is incorporated into the heat transfer coil housing equipment so as to introduce a fully automated and self-cleaning mechanism. This self-cleaning coil design fully automates the cleaning process of the heat transfer coils and ensures the HVAC system is always operating at its designed peak thermal efficiency, regardless of coil depth and operating environment. The present disclosure also contemplates the generation and use of a maintenance spray that is applied in between cleaning cycles. For example, a fine enzyme mist can be applied to prevent formation of biofilms. A fine disinfectant mist can be applied for similar purposes and/or to kill microbes. A fine deodorizing mist can be applied.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A depicts cleaning foam just starting to exit the back side of a heat transfer coil of a heat exchange system of an HVAC system;

FIG. 1B depicts the cleaning foam accumulating as it continues to exit the back side of the heat transfer coil of FIG. 1A;

FIG. 2 illustrates an example of a cleaning foam generating system;

FIG. 3A illustrates an example of a vertical deep HVAC coil with a self-cleaning mechanism;

FIG. 3B illustrates an example of a horizontal deep HVAC coil with a self-cleaning mechanism;

FIG. 3C illustrates an example of a top-down deep HVAC coil with a self-cleaning mechanism;

FIGS. 4A-4B illustrate examples of deep HVAC coil with a self-cleaning mechanism implemented in a residential and a commercial environment;

FIGS. 5A-5D illustrate an example of a top-down deep HVAC coil with a self-cleaning mechanism and operating the self-cleaning mechanism;

FIG. 6 is a diagram that schematically illustrates an example system for automatically generating cleaning foam or maintenance spray for delivery to a heat transfer coil;

FIG. 7 is a decision tree that schematically illustrates an example controller system for automatically controlling the cleaning foam or maintenance spray generating system and the cleaning or maintenance schedule;

FIG. 8 is a diagram that schematically illustrates an example system for generating cleaning foam or maintenance spray and delivering it to multiple HVAC heat transfer coils;

FIG. 9 is a diagram that schematically illustrates an example system for generating cleaning foam or maintenance spray and delivering it to an air handler coil wall of an HVAC system;

FIG. 10 is a box diagram that schematically illustrates an example architecture of a controller configured to control the cleaning and maintenance apparatus of FIGS. 1A-1C, 2, and/or 3A-3B;

FIG. 11 is a box diagram that schematically illustrates an example architecture of a foam or spray generator of FIGS. 1A-1C, 2, and/or 3A-3B; and

FIG. 12 is a flowchart that schematically illustrates an example method for automatically cleaning and maintaining a heat transfer coil of an HVAC system.

### DETAILED DESCRIPTION

Disclosed are devices and systems of deep HVAC coils with built-in self-cleaning mechanisms and enhanced heat transfer, and methods of cleaning thereof. For example, some embodiments of a deep HVAC coil include a series of built-in self-cleaning mechanisms (e.g., emitters or injection ports) disposed and spaced-apart among an array of heat transfer coils. Depending on the size and depth of the deep HVAC coil, the number of self-cleaning mechanisms may vary. The disposition and installation of self-cleaning mechanisms in the deep coil HVAC is configured to provide an even distribution and injection of a desired cleaning solution or foam that sufficiently covers an internal surface area of the deep HVAC coils and sufficiently fills an internal volume of the deep HVAC coils.

In some embodiments, “deep HVAC coil” refers to the number of rows of coils, which can be at least 24 rows deep, and/or an actual depth of at least 18 inches, such as at least about 24 inches, at least about 36 inches, or at least about 48 inches, at least about 60 inches, or at least about 72 inches. The depth of the coil corresponds to the length of the cooling path. It will be appreciated that the disclosed cleaning systems can be incorporated into any sized coil and any depth of coil arrangement.

The cleaning mechanisms (e.g., injection ports or emitters) can be space-apart at defined intervals along the depth of the coils, which is the same thing as being at defined intervals along the length of the cooling path. By way of example and not limitation, it may be desirable for the cleaning mechanisms to be spaced-apart at predefined depth (cooling path length) intervals, such as intervals of 1 inch, 2 inches, 3 inches, 4 inches, 5 inches, 6 inches, 8 inches, 10 inches, 12 inches, 16 inches, 20 inches, or 24 inches, combinations thereof, and intervals within a range define by any two of the foregoing values. In some embodiments, the first cleaning mechanism is can be positioned to inject or emit foam or spray at or near the front surface where moving air first enters the coil, with each successive cleaning mechanism being configured to inject or emit foam or spray within the interior of the coils at defined depth intervals. By way of example, if the depth of the HVAC coil is 36 inches and the cleaning mechanisms are spaced-apart at intervals of 6 inches, the cleaning mechanisms will be located, from front to back at the following depth positions: 0 inch (front), 6 inches, 12 inches, 18 inches, 24 inches, and 30 inches. If spacing is 12 inches, then the cleaning mechanisms will be located, from front to back at the following depth positions: 0 inch (front), 12 inches, and 24 inches.

The spacing of the cleaning mechanisms can be selected to replenish foam that becomes spent or broken down as it moves through the depth of the HVAC coil. For example, if the cleaning foam begins to lose its ability to clean spaces in the coil after penetrating through a depth of 6 inches, then positioning the cleaning mechanisms to inject or emit new cleaning foam every 6 inches will ensure that cleaning foam of essentially full strength to perform a desired cleaning function will be present along the entire depth (cooling path) of the coil.

Methods of Cleaning Deep HVAC Coils with Self-Cleaning Mechanisms

In some embodiments, a method of cleaning deep HVAC coils may include injecting or emitting a cleaning foam into a deep HVAC coil system at predetermined depth intervals, wherein the deep HVAC coil system includes a plurality of heat transfer coils (such as condenser and evaporator coils) and a plurality of foam or spray injection coils intermittently disposed along the depth of each of the plurality of heat transfer coils. In some embodiments, the foam or spray emitters are arranged vertically with respect to the heat transfer coils. In some embodiments, the foam or spray emitters are arranged horizontally with respect to the heat transfer coils. In some embodiments, a plurality of foam or spray injectors are disposed in a top-plate, where the top-plate is part of a deep HVAC coil housing. The method may also include flowing the cleaning foam or spray through the deep HVAC coil system, wherein the cleaning foam cleans the deep HVAC coil system. One or more maintenance sprays, such as enzyme mist, disinfectant mist, and/or deodorizer mist, can be applied to the coils in between cleaning cycles.

Flowing the cleaning foam or liquid through the deep HVAC coil system may include utilizing compressed air to force the cleaning foam or liquid through the deep HVAC coils. Additionally, or alternatively, the force of gravity may cause flow of the cleaning foam or liquid vertically through the deep HVAC coils.

One embodiment of a cleaning method may include a liquid injection of cleaning solution, enzyme solution, and/or another chemical treatment formulation and/or simply water so as to provide a flushing effect of a deep HVAC coil system. In some embodiments, the cleaning solution is a chemical-free enzyme cleaning solution. In some embodiments, the cleaning solution includes a surfactant that forms a cleaning foam. In some embodiments, the coils are flushed before injecting the cleaning foam or solution. In some embodiments, the coils are flushed after injecting the cleaning foam so as to flush out any residual cleaning foam from the coils.

As part of a cleaning method, once the chemical foam enters the targeted vessel (i.e., air handler coils), it can proceed to fill the entire internal volume space. Once full, a sensor may be configured to stop the injection of new chemical foam and feed compressed air through the coils. Since there can be an open outlet for drainage of spent foam or liquid, the coils do not become pressurized; however, continuous injection of compressed air serves to generate mechanical agitation through the foam filled coils. This mechanical agitation, combined with the chemical reactivity of the foam or spray, works to break apart residues on the coils. After a predetermined period of time, a sensor may be configured to inject new foam or liquid into the vessel, pushing out spent foam or liquid, which creates a conveyor effect, whereby the loose particles of residues fall into the foam and are carried out of the coil system. The spent foam can be removed and disposed of using known means, such as via a drain or vacuum line.

In some embodiments, the method may include operating an air handler of the HVAC system causing forced air to pass through a plurality of spaces between fins of one or more heat-transfer coils, thereby assisting movement of the cleaning foam through and removal of debris from the plurality of spaces. Coil fins are long sheets that run the entire length of the air handler and have tiny spaces between each sheet, like a stack of paper. The air handler may comprise a blower that applies air pressure to a side of the coils and pushes air through the plurality of spaces. Alternatively, the air handler may comprise a blower that reduces air pressure to a side of the coils and pulls air through the plurality of spaces.

Additionally, and/or alternatively, the method may involve introducing air from at least one of an external air supply, external fan, pressurized air line, or portable blower into the plurality of spaces to assist movement of the cleaning foam and removal of debris through the spaces of the coils.

In some embodiments, different types of foam or solution can be used in sequence to address specific problems. For example, the method may involve initially applying a thicker cleaning foam to the plurality of spaces to increase residence time and contact of the foam to the surfaces of the coils and thereafter applying a thinner cleaning foam to the plurality of spaces to accelerate movement of the cleaning foam and removed debris through the plurality of spaces. A maintenance spray can be periodically applied between periodic cleaning cycles.

In general, removing debris from inside the coils causes the HVAC system to operate with higher cooling efficiency, reduced energy consumption, and increased air flow. In some embodiments, the method may involve identifying one or more blockage areas within the one or more coils of the deep HVAC coil system and applying additional cleaning foam to the one or more blockage areas. In some embodiments, the method may involve closing off one or more spaces within the coils to direct the cleaning foam, for example, to the one or more blockage areas to more efficiently disrupt and remove the blockage.

The ability to clean and sanitize coils found in HVAC systems without damaging or shutting down the HVAC system provides a whole new approach to significantly reduce energy consumption, improve cooling capacity, and improve human health. This ability to clean and sanitize deep HVAC coils also enables a whole new approach to the design of heat transfer coils, enabling designs of much greater depth than the conventional 8-row and 12-row coils. For example, deep HVAC coil systems with 24-row, 48-row, 100-row, and up to 150-row coils are enabled. The measured depth of deep HVAC coils can be at least 18 inches, such as at least about 20 inches, at least about 24 inches, at least about 30 inches, at least about 36 inches, at least about 42 inches, at least about 48 inches, at least about 60 inches, or at least about 72 inches. This process has been shown to improve the efficiency of commercial air handlers by up to 90%, such as at least 60%, 65%, 70%, 75%, 80%, 85%, or 90%, or a range defined by any two of the foregoing values, which has been achieved by removing the fouling debris buildup deep inside the coils.

The method includes injecting cleaning foam or spray at defined intervals along the depth of the coils, i.e., at defined intervals along the length of the cooling path. By way of example and not limitation, it may be desirable to inject cleaning foam or spray at predefined depth (cooling path length) intervals, such as at intervals of 1 inch, 2 inches, 3 inches, 4 inches, 5 inches, 6 inches, 8 inches, 10 inches, 12 inches, 16 inches, 20 inches, or 24 inches, combinations thereof, and intervals within a range define by any two of the foregoing values. In some embodiments, a first portion of foam or spray is injected at or near the front surface where moving air first enters the coil, with each successive portions of foam or spray being injected within the interior of the coils at defined depth intervals. By way of example, if the depth of the HVAC coil is 36 inches and the defined injection intervals are 6 inches, the foam or spray will be injected, from front to back at the following depth positions: 0 inch (front), 6 inches, 12 inches, 18 inches, 24 inches, and 30 inches. If spacing is 12 inches, then the foam or spray will be injected, from front to back at the following depth positions: 0 inch (front), 12 inches, and 24 inches.

The spacing of where the cleaning form or spray is injected can be selected to replenish foam or spray that becomes spent or broken down as it moves through the depth of the HVAC coil. For example, if the cleaning foam begins to lose its ability to clean spaces in the coil after penetrating through a depth of 6 inches, then injecting new cleaning foam every 6 inches will ensure that cleaning foam of essentially full strength to perform a desired cleaning function will be present along the entire depth (cooling path) of the coil

The HVAC system is also able to greatly increase the volume of air moving through the air handler with reduced energy load. This innovation can also be a single platform solution that can be applied to any size or type HVAC system and is equally effective if the HVAC system is a push- or pull-type system. This means the blower within the air handler is pushing air through the coils or drawing air via a reverse suction. In addition, the innovation provides a means to deliver near perfect surface area coverage deep within the coils, making it possible to remove biofilms and eliminate bacteria, fungi and/or other microorganisms found deep within HVAC coils. The innovation provides, for example, a highly effective and cost-effective solution for medical facilities to quickly and effectively mitigate their antibiotic resistant microbe crisis by sanitizing and disinfecting the sole area within the medical facility (deep inside the coils) that is currently unreachable. Finally, this innovation is a truly sustainable solution. The innovation uses approximately 95% less water than conventional pressure washing methods and can use no toxic, hazardous, or damaging chemicals. In addition, the innovation operates at low pressure, making it possible to clean HVAC coils without causing significant damage (e.g., bending of the fins, as can occurring using high pressure washing or sprays).

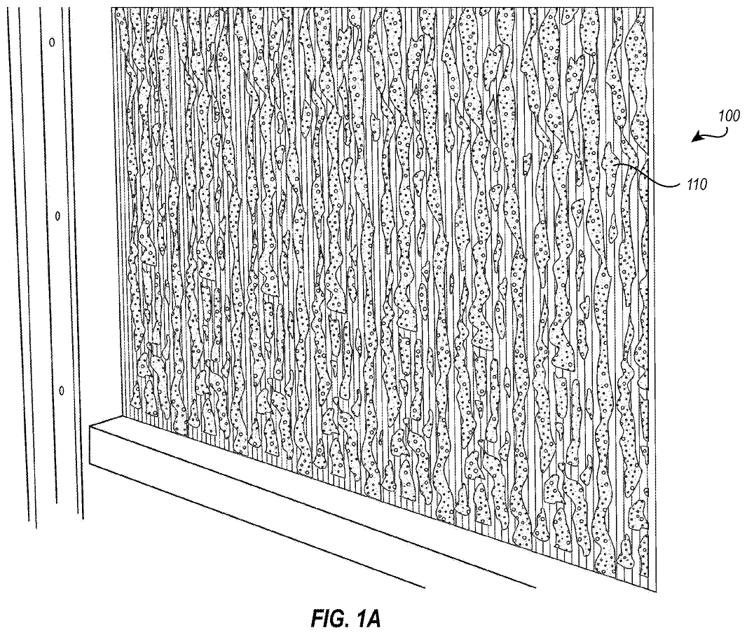

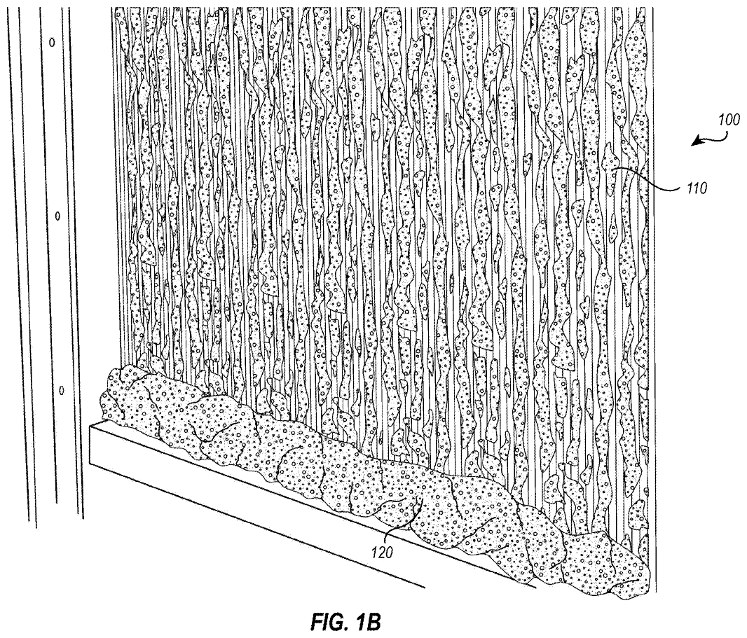

FIGS. 1A and 1B illustrate an application and movement of cleaning foam 110 from one side of a deep HVAC coil 100 and exiting the opposite side after passing through spaces within or between the coils and coil fins. Preferred formulations for cleaning HVAC coils are pH neutral, non-toxic, non-hazardous, and non-odorous. In some embodiments, foam that is applied resides inside the coils and then naturally breaks down or sweats out of the system via a natural process of condensation on the coils. This helps deliver extended residence time for the activated foam to work and remove all biofilms, dirt, debris, and/or microorganisms. The process of condensation on the coils also helps to flush out the system. Further, the condensation evaporates off, beneficially leaving behind beneficial enzymes to combat biofilms.

In energy savings, improvements may be seen in at least two ways. First, air flow is improved through the system by removing bacteria, biofilm, dirt, grime or other debris. This reduces back pressure, or pressure drop across the coils (differential of pressure before and after the coil). Reducing the pressure drop of an air handler directly reduces the electricity load on the blower that is required to push and/or pull air through the coils. In simplistic terms, a 1% reduction in pressure should equate to a 1% reduction in the blower's brake horsepower. This enables using a smaller motor for the blower, which leads to reduced energy consumption.

In addition to reducing back pressure by removing biofilms and/or other fouling residues from the interior surfaces of the coils, heat transfer by the coils is also improved so that air passing through the coils gets colder faster. This helps reduce the energy load of chilled water chillers. Biofilms reduce cooling capacity by restricting air flow, reducing contact area between moving air and coil surfaces, and providing a layer of organic matter acting as insulation. Removing biofilms increases air flow and contact area between moving air and coil surfaces and eliminates insulation effects.

The ability of the disclosed methods and systems to deliver a high degree of surface area coverage by the cleaning foam enables the sanitization and disinfection of deep HVAC coils so as to mitigate the growth of antibiotic resistant microbes, such as staph and methicillin-resistant Staphylococcus aureus (MRSA) in hospitals. Cleaning hospital HVAC coils will reduce energy consumption, and, more importantly, the process enables sanitization and disinfection of coils that currently spread disease and infection through the ventilation system. It is the coils and the air handler system that makes it possible for microbes to recirculate and travel throughout a medical facility. Being able to clean and disinfect the deep HVAC coils beneficially provides improvements in hospital air quality and health. The foam may optionally be used to deliver disinfectant and/or non-stick coatings onto the surface of coils that, when deposited, can inhibit future bacteria from growing.

### Cleaning Solution and Foam Generators

It should be understood that the inventive methods can be carried out using a variety of different cleaning foams or solutions. In some embodiments, a foam generating system for producing cleaning foam used in cleaning a heating, ventilation and air conditioning (HVAC) system of a building comprises: (1) an air pump or pressurized vessel that provides pressurized air; (2) one or more inlets for receiving water, the pressurized air, and a surfactant; (3) one or more air-driven pumps for pressurizing at least the surfactant, the one or more air-driven pumps being driven by the pressurized air; (4) a manifold for receiving and mixing the pressurized air, water, and surfactant so as to form pressurized cleaning foam; and (5) an outlet in fluid communication with the manifold for discharging the pressurized cleaning foam.

In some embodiments, the cleaning foam comprises water, air, surfactant, and (optionally) enzymes and/or chemical(s). Water, air and surfactant generate foam when mixed. The optional enzymes and/or chemical(s) can break down and remove biofilms, dirt and/or debris adhered to or associated with the biofilm, and/or kill and remove microbes, including bacteria, viruses and/or fungi, and disinfect the HVAC coils. Advantageously, the cleaning foam can be free of volatile organic compounds (VOCs) and/or is pH neutral, so as to be non- or less corrosive. The cleaning foam can include at least one of hydrogen peroxide, chlorine dioxide, halide salt, hypochlorite salt, organic solvent, quaternary ammonium compound, acid, base, and/or chelating agent. Preferred formulations for cleaning HVAC coils are pH neutral, non-toxic, non-hazardous, and non-odorous. In some embodiments, foam that is applied resides inside the coils and then naturally breaks down or sweats out of the system via a natural process of condensation on the coils. This helps deliver extended residence time for the activated foam to work and remove all biofilms, dirt, debris, and microorganisms.

In some embodiments, the cleaning foam or spray can be injected or applied to the coils under sufficiently low pressure so as to not damage the heat-transfer coils, including so as to not damage bendable heat-transfer fins of the coils. In some embodiments, the low-pressure foam or spray is discharged from a discharge nozzle at a pressure that is no greater than about 8 psi, preferably no greater than about 5 psi, more preferably no greater than about 3 psi, even more preferably no greater than about 1 psi, such as at a pressure of about 0.5 psi or less.

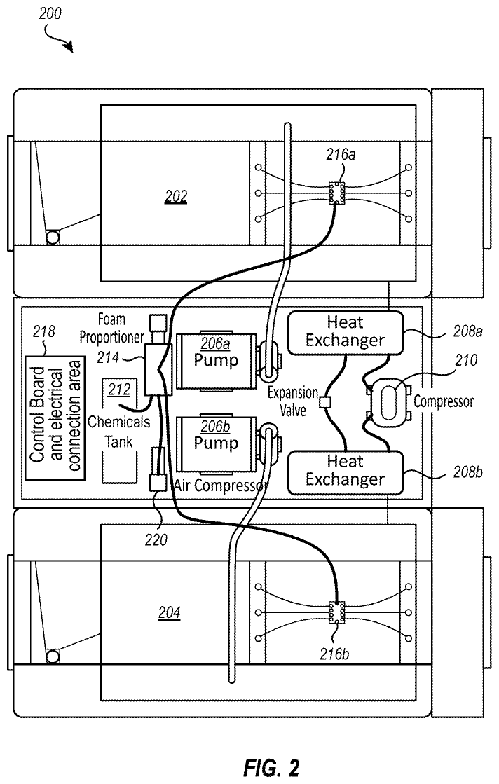

FIG. 2 illustrates an example cleaning foam generating system 200 used with evaporation and condensing coils of an HVAC system. At least one deep HVAC coil system 202, 204 with self-cleaning mechanisms may be in communication with the cleaning foam generating system 200. The self-cleaning mechanisms, which in some embodiments may be foaming coils, are in fluid communication with the cleaning foam generating system 200. The system includes inlet and outlet fluid communication lines, at least one compressor 210 that exchanges coolant between heat exchangers 208a, 208b and in cooperation with an expansion valve 211.

Also provided is an enzyme and/or chemical reservoir tank 212 and a foam proportioner 214 for controlling the input of air, water, enzymes and/or chemical(s), and surfactant, respectively, into the system 200. The reservoir tank 212 may be sized according to the size of the building the deep HVAC coil system is being used in. Additionally and/or alternatively, the reservoir tank 212 may be removable from the foam generating system 200, enabling quick and easy re-filling of the tank. The foam generating system 200 also includes at least one pump 206 (e.g., 206a, 206b) and a control board 218. The compressor 210 circulates and pressurizes refrigerant and/or chilled water throughout the deep HVAC coils via injectors 216a, 216b. The at least one pump 206 is configured to pump enzymes and/or chemicals from the reservoir tank 212 throughout the system and deep HVAC coils. An air compressor 220 can be used to operate pumps 206 and compressor 210 and to provide air for foam generation.

In some embodiments, the control board 218 is a programmable logic controller (PLC) board. The PLC board 218 may include one or more microprocessors to control one or more cleaning foam generating systems. The one or more microprocessors may also be configured to control other elements of the deep HVAC coil system. For example, the one or more microprocessors may be configured to switch on or off the air handler and/or compressor during a method of cleaning. For example, the one or more microprocessors may switch off the air handler while cleaning foam is being injected into the deep HVAC coils. Once an amount of cleaning foam has been injected, the one or more microprocessors may be configured to switch the air handler back on, pulling the cleaning foam throughout the deep HVAC coil.

The PLC board 218 may include sensors for controlling the foam proportioner and the ultimate foam formulation for a cleaning process. The PLC board 218 may be connected and in communication with various other sensors which automatically activate if a differential pressure within the coil system goes above or below a predetermined threshold level. The foam proportioner may be automatically activated due to the differential pressure.

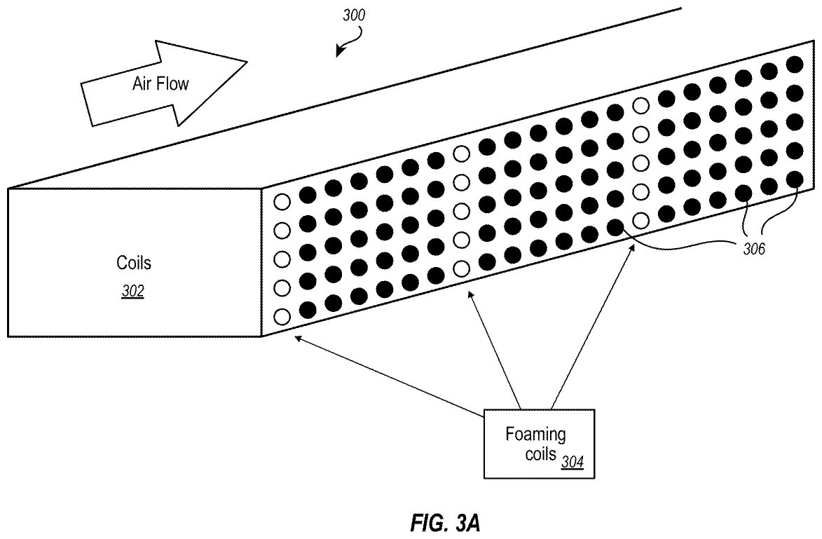

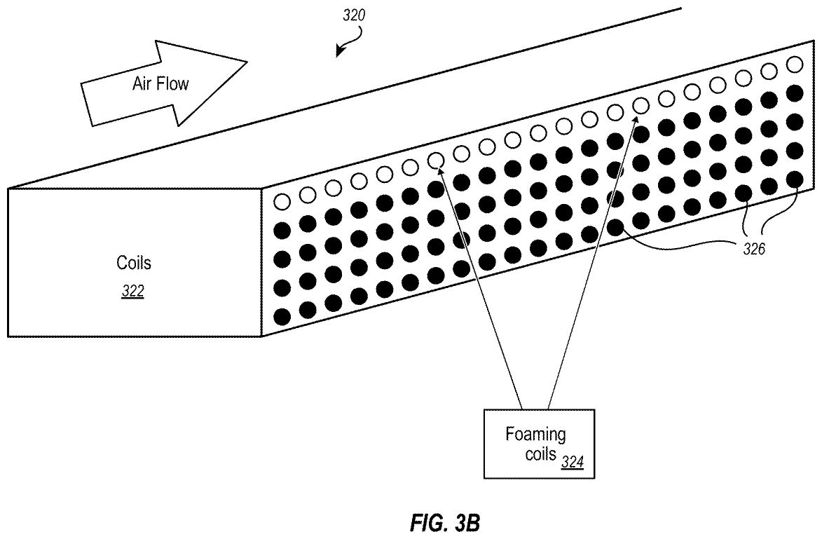

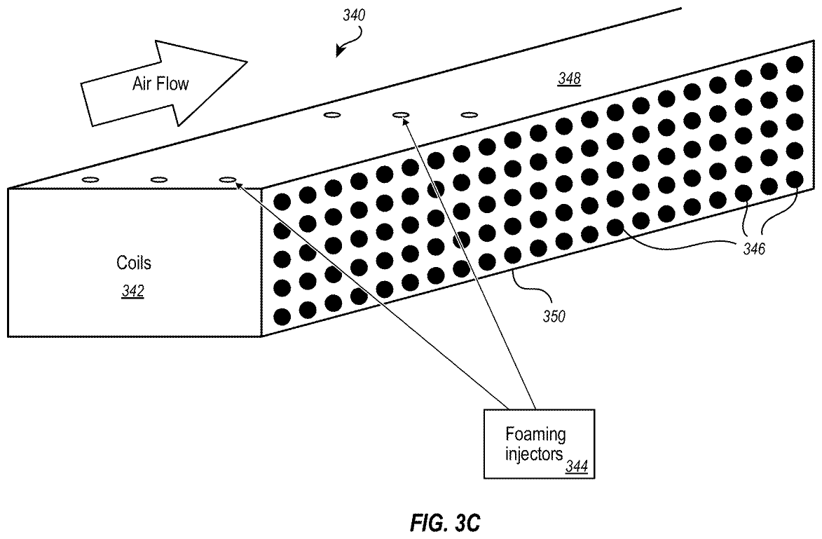

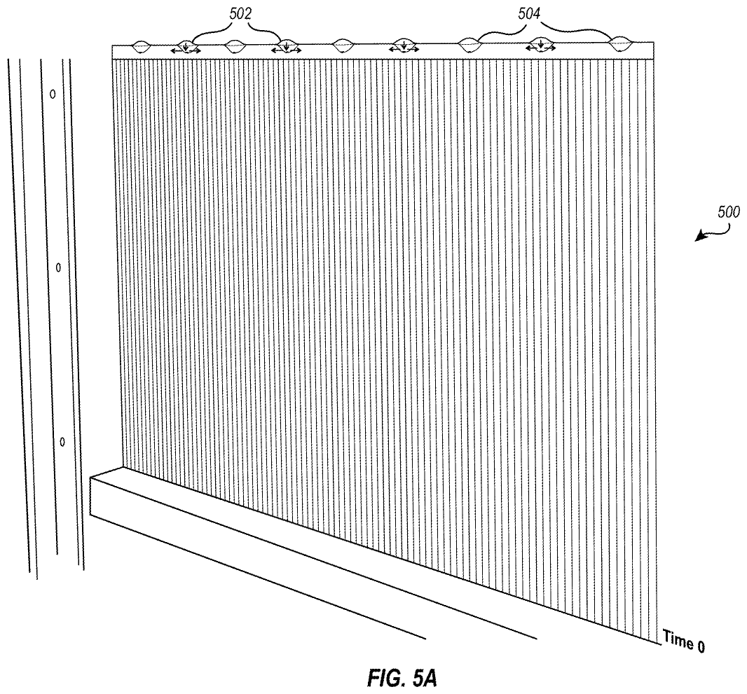

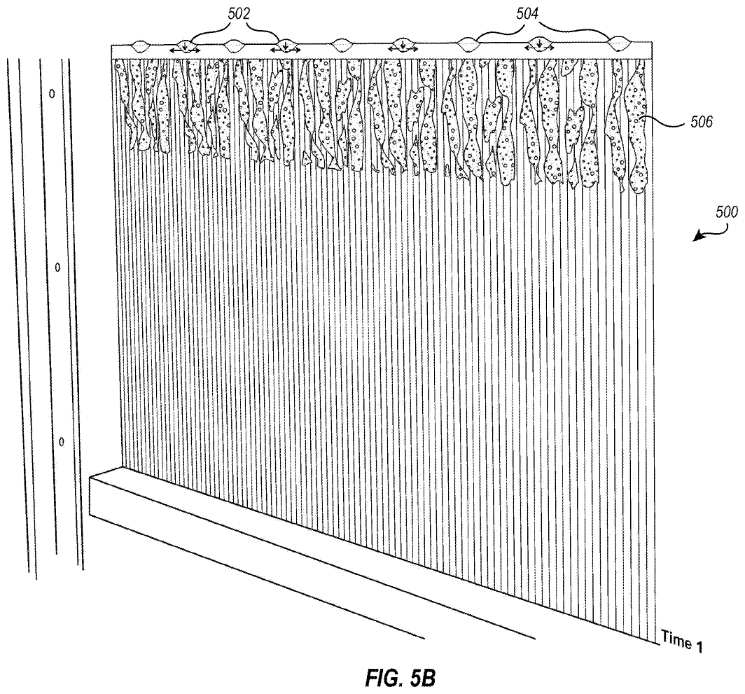

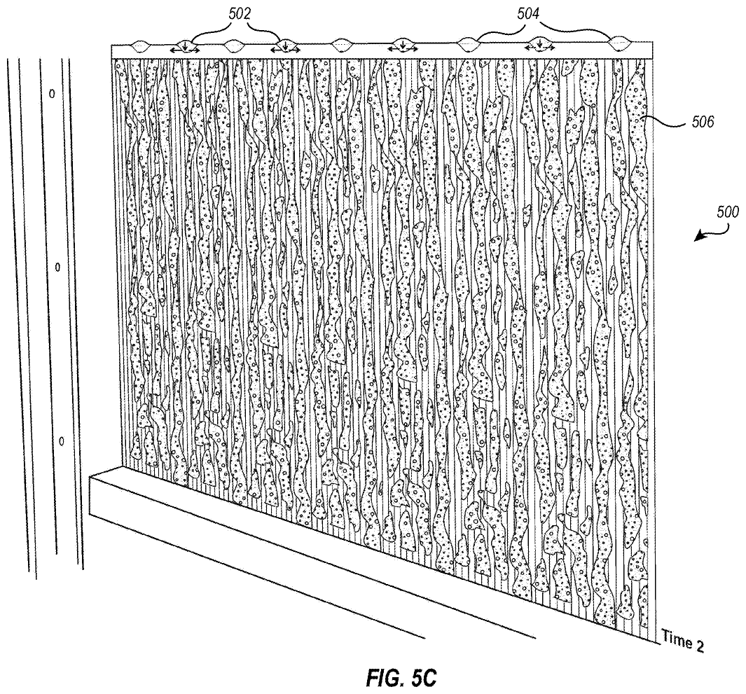

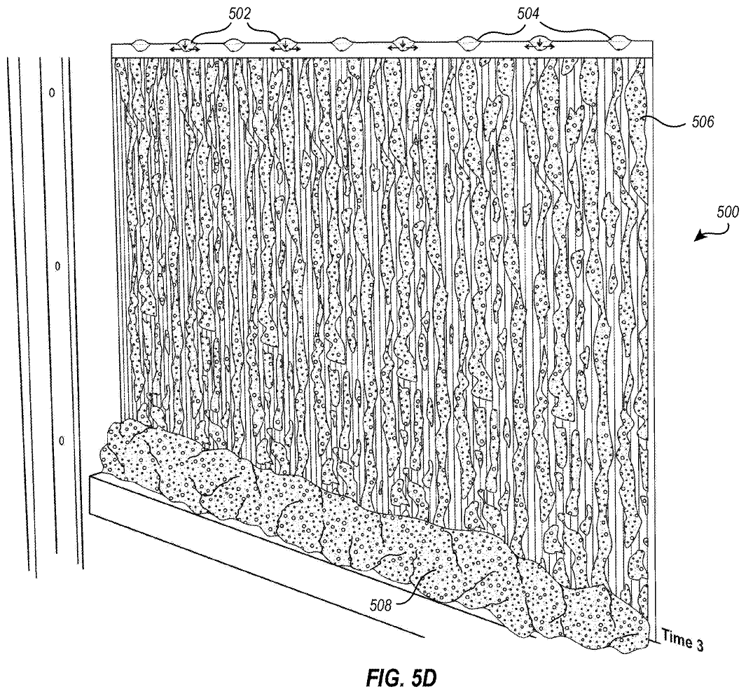

The illustrated cleaning foam generating system 200 may be modular and connectable with one or more additional cleaning foam generating systems. The cleaning foam generating system is configured to simply be plugged in and connected to an existing HVAC air handler. The cleaning foam generating system may be in communication with a least one and/or a plurality of a deep HVAC coil systems with self-cleaning mechanisms, such as the deep HVAC coil system illustrated in any one of FIGS. 3A-3C and 5A-5D.

For removing biofilms, there are two primary formulations to include in the foam or spray, either alone or in combination. The first involves using enzymes, such as those one would find in probiotics and that actively turn the biofilm into a food source and digest the biofilm. In this approach, a wide range of enzymes can be used to address biofilms. Also, probiotic cleaners can be used. Another approach is the use of sodium chloride which, when used in very small volumes, actively works to break down the biofilm matrix into small particles. The advantage of both approaches is that they are pH neutral, non-reactive to metal surfaces, and non-odorous. Other formulations can be introduced to help break down organics, such as traces of hydrogen peroxide or chlorine dioxide. Quaternary ammonium compounds can also be used to sanitize and kill microbes. Examples include benzalkonium chloride compounds.

### Cleaning Sequences

In some embodiments, different types of foam can be used in sequence to address specific problems. For example, the method may involve initially applying a thicker cleaning foam to the plurality of spaces to increase residence time and contact of the cleaning foam to the surfaces of the coils and thereafter applying a thinner cleaning foam to the plurality of spaces to accelerate movement of the cleaning foam and removed debris through the plurality of spaces.

In some embodiments, an enzyme foam or solution (e.g., fine mist) may be injected and applied to breakdown and remove biofilms. Subsequently, a cleaning foam may be injected and applied absorb and remove the biofilms and/or any other debris. Finally, a flushing solution may be injected to clean out any remaining cleaning foam and any loose debris that may still be on the deep HVAC coils.

The PLC board 218 may be programmed to be set to automatically clean the coils as frequently or infrequently as is desired, which can range from hourly treatments to annual treatments. In addition, the PLC board 218 can be programmed to employ various cleaning cycles such as a straight water flush cycle, where pure water is directly injected into the coils to flush out any impurities or fouling material that may be present deep within the coils. This flushing process may also be employed to remove other more corrosive types of cleaning agents if incorporated within the desired cleaning formulation. In some embodiments, an automatically implemented cleaning process may be monitored and controlled remotely.

Deep HVAC Coils with Self-Cleaning Mechanisms

Disclosed embodiments of a deep HVAC coil system with self-cleaning mechanisms may include at least one heat transfer coil, where the at least one heat transfer coil can include at least one evaporative coil and/or at least one condensing coil. Some embodiments of the deep HVAC coil system may also include a housing frame, at least one injection port, at least one inlet and at least one outlet, a mixing chamber, a centralized control, an air compressor and/or a chiller compressor.

FIG. 3A illustrates an example of a self-cleaning system 300 for a vertical deep HVAC coil 302 with a self-cleaning mechanism. As illustrated, the deep HVAC coil 302 includes a series or plurality of self-cleaning mechanisms 304 intermittently dispersed at predefined intervals throughout an array of heat transfer coils 306 (i.e., an array of condensing or evaporative coils). As illustrated in FIG. 3A, the plurality of self-cleaning mechanisms 304 are a plurality of foam injection coils 304 vertically oriented and disposed among the heat transfer coils 306 at spaced-apart intervals. The foam injection coils 304 may be dispersed evenly throughout the depth of the HVAC coils. For example, in a 30-row coil, foaming coils may be at row 1 and row 15. For example, in a 100-row coil, foam injection coils 304 may be at rows 1, 25, 50 and 75. Beneficially, even distribution of the foam injection coils 304 allows for even distribution of the cleaning foam and efficiently cleaning of the deep HVAC coils. The foam injection coils 304 may also be adapted to emit a liquid spray, such as a fine enzyme, disinfectant and/or deodorizing mist.

By way of non-limiting example, in the case where the injection coils 304 and cooling coils 306 illustrated in FIG. 3A are apart from each other at 1 inch intervals, the injection coils 304 will be spaced apart at 7-inch intervals. It will be appreciated that FIG. 3A is only a schematic representation, and the number of cooling coils 306 between each column of injection coils 304 may differ from what is illustrated.

The foam injection coils 304 may inject cleaning foam simultaneously, or near simultaneously. Each foam injection coil 304 may be evenly perforated with small diameter holes, or injection ports, enabling simultaneous delivery and application of a cleaning foam or another cleaning solution to the deep HVAC coils 302. The injection ports may be constructed of densely packed injection points and/or widely separated injection points, depending on coil design. The thickness and density of the cleaning foam may be altered via a control board according to the size, length and volume of the deep HVAC coils being cleaned. For example, the cleaning foam may be a liquid and more fluid type of foam or may be a very thick, shaving cream-like foam.

The distribution of the foam injection coils 304 enables injection of the cleaning foam while the air handler of the deep HVAC coil system is still on. Beneficially, the air handler will pull the cleaning foam laterally (e.g., horizontally) through the deep HVAC coils 302. The cleaning foam will be pulled uniformly (due to the even distribution of foaming coils) through the deep HVAC coils by the air handler.

As described above with reference to FIG. 2, at least one deep HVAC coil system 200 with self-cleaning mechanisms may be in communication with a foam generating system. The self-cleaning mechanisms, which in some embodiments may be foaming coils, are in fluid communication with the cleaning foam generating system. The cleaning foam generating system may include an air compressor and/or compressed line system, a reservoir of enzymes and/or chemicals, and/or an external water line. The cleaning foam generating system may be controlled by a programmable logic controller (PLC) board that is connected to various sensors which automatically activate if a differential pressure within the coil system goes above or below a predetermined threshold level.

The PLC board can be programmed to be set to automatically clean the coils as frequently or infrequently as is desired, which can range from hourly treatments to annual treatments. In addition, the PLC board can be programmed to employ various cleaning cycles such as a straight water flush cycle, where pure water is directly injected into the coils to flush out any impurities or fouling material that may be present deep within the coils. This flushing process may also be employed with other more corrosive types of cleaning agents if incorporated within the desired cleaning formulation. In some embodiments, an automatically implemented cleaning process may be monitored and controlled remotely.

Each foam injection coil 304 is configured to directly inject cleaning foam into the adjacent heat transfer coils 306. The intermittent dispersion of a plurality of foam injection coils 304 enables the design of any depth of heat transfer coils (for example, an array of 100-row coils) without the concerns for fouling or plugging that plague conventional HVAC systems. Further, deeper coils (such as 36-row, 40-row, 48-row, and up to 150-row coils) provide a greater residency time for the air moving through the deep HVAC coils inside an air handler. Residency time relates to how much time the air spends circulating through the air handler, being exposed to the heat transfer coils contained therein. Since the air is moving through a much deeper coil 302, the residency time is greater than in a typical HVAC system. In other words, the air circulating through the deep HVAC coil system spends more time in contact with the heat transfer coils. This means that instead of circulating a 45° F. refrigerant, which consumes immense amounts of energy and is highly carbon intensive, the circulating refrigerant may be kept at approximately 60-63° F. to achieve the same climate-controlled environment. That is, a temperature of approximately 65° F. can be achieved and maintained inside a building and/or room using approximately 60-63° F. circulating refrigerant, beneficially cutting down on energy consumption and CO2 production. Decreases in both energy consumption and CO2 production beneficially reduces the costs of running an HVAC system and the contribution to climate change from HVAC systems.

Additionally, circulating an approximately 60-63° F. refrigerant means the compressor does not need to generate as much cold water, which may be used as a refrigerant. Thus, the compressor's motor itself can be smaller and run at slower speeds, beneficially reducing the heat coming off the motor and expanding the motor's lifespan. Due to this reduction, it is possible to expel any heat generated by the motor using a closed-loop water system heat sink that eliminates the need for open atmosphere cooling towers, beneficially resulting in smaller HVAC systems overall. During the winter season, this loop enables heat to be pumped into a building and expel cool air into an external atmosphere. During the summer season, this loop enables heat to be expelled into the external atmosphere and cool air to be pumped into the building.

The disclosed techniques and processes of how coils are cleaned can involve harnessing the energy of the HVAC system itself as a means to either draw or push cleaning foam through the coils. As described above, the weakness of current cleaning processes involves the technical problem of how to inject cleaning solutions completely and efficiently through the coils. Because of the tightly packed nature of the coils and their fins, the inability to access the middle of the coils from the top or sides, plus the natural tendency of liquids to fall by force of gravity to the bottom of the coils once they lose the pushing force as they are being injected, means that penetrating coils more than a few inches of depth with cleaning foam has typically not been possible. However, cleaning foams have properties of comprising more air than liquid (e.g., at least 90%, 93%, or 95% air and less than 10%, 7%, or 5% liquid) and are able to cling to vertical surfaces, providing an ideal carrying mechanism for introducing cleaning solutions that can work to break down biofilms, dust, grease, and/or other fouling agents. In addition, cleaning foam, which comprises tiny air bubbles, possesses the unique property of being able to collect particles and keep them suspended in its bubble matrix. Analogous to how a glacier can pick up giant boulders and move them down a valley to be later deposited, foam works in a similar manner when it is flowing through a system, such as through coils of an HVAC system.

FIG. 3B illustrates an example of a self-cleaning system 320 for a horizontal deep HVAC coil 322 with a self-cleaning mechanism 324. As illustrated, the plurality of self-cleaning mechanisms 324 are arranged horizontally across the top layer of deep HVAC coils 322. Similar to the embodiment of FIG. 3A, the illustrated self-cleaning mechanisms 324 are a plurality of foam injection coils 324. The foam injection coils 324 may inject cleaning foam (or alternatively a spray or mist) simultaneously, or near simultaneously. Each foam injection coil 324 may be evenly perforated with small diameter holes, or injection ports, enabling simultaneous delivery and application of a cleaning foam or another cleaning solution to the deep HVAC coils 322. The injection ports may be constructed of densely packed injection points and/or widely separated injection points, depending on coil design. The thickness and density of the cleaning foam may be altered via a control board according to the size, length and volume of the deep HVAC coils being cleaned. For example, the cleaning foam may be a liquid and more fluid type of foam or may be a very thick, shaving cream-like foam.

With a horizontal orientation, the cleaning foam will be injected and fall toward the bottom of the deep HVAC coils 322. In operation, the air handler of the HVAC may need to be turned off during injection of the cleaning foam. The air handler may remain off for an amount of time, to allow the cleaning foam to fall with the force of gravity through the deep HVAC coils 322. After an amount of time (for example, 30 seconds, 45 seconds, 1 minute or 1.5 minutes), the air handler may be turned back on to draw the cleaning foam laterally through the deep HVAC coils 322. The lateral draw of the cleaning foam enables even distribution of the cleaning foam and even cleaning of the deep HVAC coils 322.

By way of non-limiting example, in the case where the injection coils 344 illustrated in FIG. 3B are apart from each other at 2-inch intervals, the injection coils 344 will introduce cleaning foam at 2-inch intervals along the depth of the deep HVAC coil 322. It will be appreciated that FIG. 3B is only a schematic representation, and the number and spacing of cooling coils 336 and injection coils 324 may differ from what is illustrated.

FIG. 3C illustrates an example of a self-cleaning system 340 for a top-down deep HVAC coil 342 with a self-cleaning mechanism 344. As illustrated, the deep HVAC coil 342 includes a top plate 348 having a plurality of ridges, where each ridge includes an injection port 344. The top-plate 348 and a bottom plate 350 form part of the deep HVAC coil housing. There is a gap between the top plate 348 and the rows of heat transfer coils 346. In some embodiments, the gap is up to 1.5 inches, such as 0.5, 0.7, 0.9, 1, 1.2, 1.3 inches or a range defined by two of the foregoing values. In operation, the injectors inject an amount of cleaning foam (or other cleaning solution) through the injection ports 344. The cleaning foam will first fill the gap between the top-plate 350 and the rows of coils 346. Then the cleaning foam will gradually and uniformly descend through the rows of coils 346 and coil fins. The cleaning foam may be injected while the air handler is switched on or off.

In the embodiment shown in FIG. 3C, the foam injectors 344 can be spaced-apart as shown, such as at intervals of 6 inches, 8 inches, 10 inches, or 12 inches; however, the foam may be evenly distributed beneath the top plate 348 such that the multiple locations along the depth of the coil 342 where foam enters is essentially continuous. If the cooling coils 346 are spaced-apart by 2 inches, then the egress points where foam enters and descends from the top plate 348 toward the bottom plate 350 may be thought of as being spaced apart by 2-inch intervals.

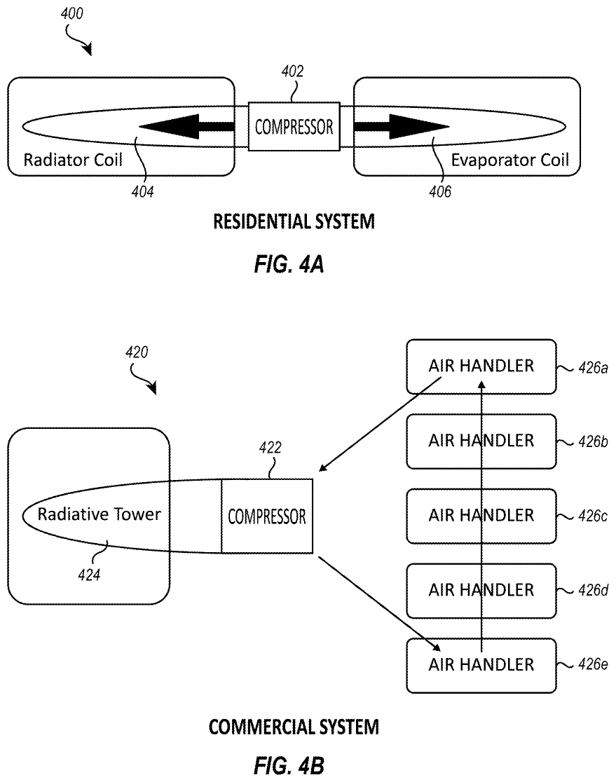

FIGS. 4A-4B illustrate examples of deep HVAC coils with a self-cleaning mechanisms implemented in a residential environment and a commercial environment. As illustrated in FIG. 4A, a residential deep HVAC coil system 400 with a self-cleaning mechanism includes a compressor 402, a radiator coil 404 and an evaporator coil 406. The radiator and evaporator coils each include at least one self-cleaning mechanism, which may be a foaming coil such as the foaming coils illustrated in FIGS. 3A-3C and 5A-4D.

In the residential system 400 of FIG. 4A, the radiator coil 404 may include a closed loop where water is circulated rather than a refrigerant (such as freon or other hydrocarbon coolant). The radiator coil 404 may enable heat transfer from the circulating water to the air being passed over the radiator coil 404 to then heat the residence where the system has been implemented. Because the radiator coil 404 includes a self-cleaning mechanism, no filters are needed, beneficially simplifying the system. The lack of filters also beneficially enables a cleaner system, as there are no filters that need to be removed and cleaned separately from the coils.

The residential system 400 in FIG. 4A also includes an evaporator coil 406 to provide cooling to the residence where the system has been implemented. In some embodiments, the evaporator coil 406 includes a closed loop where water is circulating rather than a refrigerant. In some embodiments, the water circulating through the closed loop is maintained at 60-65° F. The compressor 402 may use a refrigerant (such as freon or other hydrocarbon coolant) to cool the water circulating in the evaporator coil 406. Because the circulating water only needs to be kept at 60-65° F., the compressor 402 used in the residential deep HVAC coil system 400 may beneficially be smaller and consume less energy than a compressor used in a conventional HVAC system where circulating water or refrigerants are kept at a much lower temperature, such as 45° F. Because the evaporator coil 406 includes a self-cleaning mechanism, no filters are needed, beneficially simplifying the system.

FIG. 4B illustrates a commercial embodiment 420 of the deep HVAC coils with a self-cleaning mechanism. Commercial embodiments 420 may include a compressor 422, a radiative tower 424 and at least one air handler 426. Similar to the radiator coil 404 of the residential system 400 of FIG. 4A, the radiative tower 424 may include a closed loop circulating water enabling heat transfer from the water to the air circulating through the radiative tower 424. In this way, heat may be transferred to the building. In contrast to the evaporator coil 406 of the residential system 400, commercial embodiments 420 may include a series or plurality of air handlers 426a, 426b, 426v, 426d, 426e through which chilled water may be circulated. The chilled water may be kept at 60-65° F. The compressor 422 may use a refrigerant (such as freon) to cool the water circulating in the air handler(s) 426. Because the circulating water only needs to be kept at 60-65° F., the compressor 422 used in the commercial deep HVAC coil system 420 may beneficially be smaller and consume less energy than a compressor used in a conventional HVAC system where circulating water or refrigerants are kept at a much lower temperature, such as 45° F.

Similar to the residential system 400, both the radiative tower 424 and the series of air handlers 426a, 426b, 426c, 426d, 426e may include a self-cleaning mechanism. In some embodiments, the self-cleaning mechanism may be a plurality of foaming coils, such as the foaming coils 304, 324 illustrated in FIGS. 3A-3B, respectively. As the radiative tower 424 and the plurality of air handlers 426 include a self-cleaning mechanism, no filters are needed, beneficially simplifying the system 420. The lack of filters also beneficially enables a cleaner system, as there are no filters that need to be removed and cleaned separately from the coils.

FIGS. 5A-5D illustrate an example of a top-down deep HVAC coil 500 with a self-cleaning mechanism. As illustrated, the deep HVAC coil 500 includes a top plate having a plurality of ridges, where each ridge includes an injection port 502. Also included are pipes 504 for coolant for the deep HVAC coil 500. The top-plate and a bottom plate form part of the deep HVAC coil housing. There is a gap between the top-plate and the rows of coils. In some embodiments, the gap is up to 1.5 inches, such as 0.5, 0.7, 0.9, 1, 1.2, 1.3 inches or a range defined by two of the foregoing values. In operation, injectors inject an amount of cleaning foam (or other cleaning solution or mist) through the injection ports 502. The cleaning foam will first fill the gap between the top-plate and the rows of coils. Then the cleaning foam will gradually and uniformly descend through the rows of coils and coil fins (see FIGS. 5B-5D). The cleaning foam may be injected while the air handler is switched on or off.

By first filling up the gap, the cleaning foam will uniformly be distributed throughout the deep HVAC coil 500. In this way, the cleaning foam can reach into the tiny spaces between each coil fin to efficiently and thoroughly clean the deep HVAC coil 500. FIGS. 5B-5D illustrate foam 506 as it descends through the deep HVAC coil 500 (e.g., by gravitational force). FIG. 5A illustrates the deep HVAC coil system 500 being housed between the top-plate and the bottom plate. The top-plate is illustrated with a plurality of foam injectors 502.

FIG. 5A represents Time 0, when the cleaning foam is first filling the gap and has yet to move through the deep HVAC coil 500. FIG. 5B represents Time 1, where the cleaning foam 506 has filled the gap and is uniformly moving through the coil fins towards the bottom plate of the deep HVAC coil 500. FIG. 5C represents Time 2, when the cleaning foam 506 has substantially filled the deep HVAC coil 500. FIG. 5D represents Time 3, when the cleaning foam 506 has completely filled the deep HVAC coil and is forming a foam pool 508 at the bottom plate.

It should be understood that the features described in relation to a specific figure are applicable to the features and embodiments illustrated in all of the figures.

### Control Systems

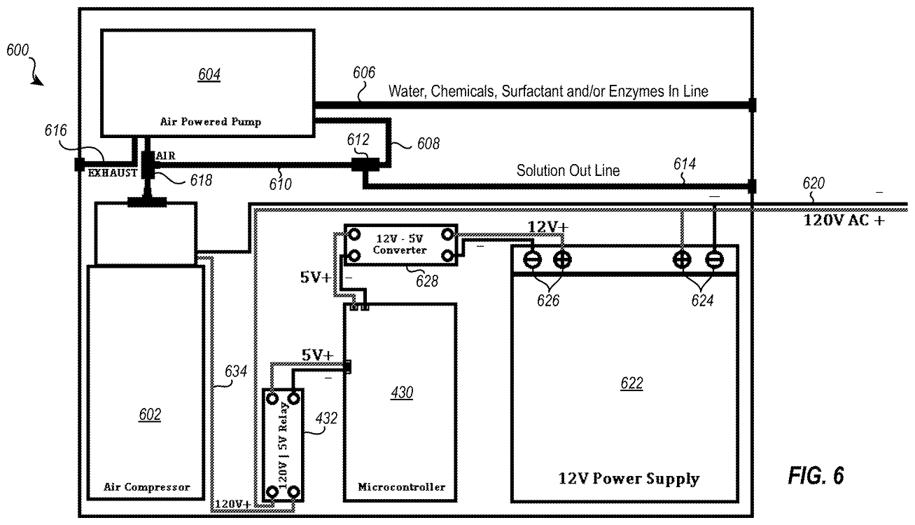

FIGS. 6-12 schematically illustrate control systems for use in controlling and operating self-cleaning deep draw HVAC coil systems. FIG. 6 is a diagram that schematically illustrates an example foam or spray generation and delivery system 600 for automatically generating cleaning foam or maintenance spray and delivering it to one or more heat transfer coils, such as in FIGS. 3A-3C and 5A-5D. The generation and delivery system 600 includes an air compression 602, which generates air that can serve the dual purpose of providing pneumatic power to one or more pumps 604 and pressurized air to deliver cleaning foam or maintenance spray to a desired location.

The one or more air powered pumps 604 are configured to receive desired inputs, such as water and one or more of chemical(s), surfactant or enzymes via input line(s) 606. In some cases, the desired inputs can be provided in the form of an aqueous solution containing water and one or more of chemical(s), surfactant or enzymes, which can change depending on the desired cleaning form or spray to be delivered to one or more heat exchange coils (not shown). The air powered pump(s) 604 can output a treatment solution stream 608, which can be combined with a side stream of pressurized air 610 from the air compressor 602 by means of a mixing manifold 612 to form a pressurized treatment solution stream 614. Exhaust gas can be expelled by an exhaust line 616 (e.g., to discharge water, water vapor, oil, etc.).

An air distribution controller 618 can provide a desired quantity and pressure of air to both the air powered pump(s) 604 and the mixing manifold 612. The mixing manifold 612 mixes the treatment solution stream 608 with the pressurized air side stream 610 to create the pressurized treatment solution stream 614. The relative amounts of the treatment solution stream 608 and pressurized air side stream 610 can be modified as desired to produce a desired type of pressurized treatment solution stream 614 to be delivered to one or more heat exchange coils.

A power supply line 620 provides power to run the foam or spray generation and delivery system 600. Although labeled as “120 V AC+” it will be understood that the power supply line 620 can provide power of other voltages, such as 220 volts, 240 volts, 330 volts, 360 volts, 440 volts, and the like. In addition, the power supply line 620 can be AC or DC. The power supply line 620 can be configured to provide power to a 12-volt power supply (e.g., battery) 622 and also to the air compressor 602. A transformer (not shown) converts power from the power supply line 620 to the appropriate voltage and delivers it to input electrodes 624 to recharge the 12-volt power supply 622. Output electrodes 626 deliver direct current to a voltage converter 628, which converts higher voltage (e.g., 12 volts) of direct current to a stepped down voltage (e.g., 5 volts), which is used to power a microcontroller 630.

The microcontroller 630 can be programmed and configured to tell the system 600 when and how to operate. In one aspect, the microcontroller 630 provides power to a relay 632, which switches the air compressor on an off by either connecting or disconnecting the 120-volt AC circuit. When the AC circuit is connected, power is provided to the air compressor 602 to power the air powered pump(s) 604. When the AC circuit is disconnected, power is not provided to the air compressor 602 and the air powered pump(s) 604 are turned off. Either the microcontroller 630 or another processor or controller (not shown) can modify which and/or the ratio of the water, chemical(s), surfactant and/or enzymes that are supplied by the input line(s) 606 to the air powered pump(s) 604 in order to change the type of foam or spray delivered the heat exchangers.

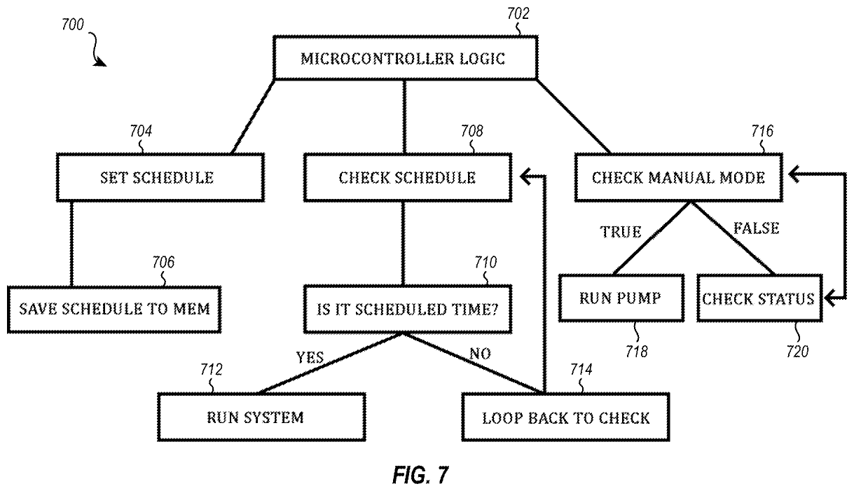

FIG. 7 is a decision tree 700 that schematically illustrates an example program for operating the foam or spray generation and delivery system 500 or any other system disclosed herein and/or that can be adapted from this disclosure. A microcontroller logic module 702 can be programmed to set a schedule 704, which can be saved to a memory module 706. The microcontroller logic module 702 can check the schedule 708 and determine whether a schedule time 710 has arisen. If yes, then the microcontroller logic module 702 can run the system 712. If not, then it can loop back to check later 714. The microcontroller logic module 702 can also check manual mode 716 and, if true, then the microcontroller logic module 702 can run a pump 718. If false, then the microcontroller logic module 702 can check the status 720 of the system to determine e.g., whether to operate automatically or manually.

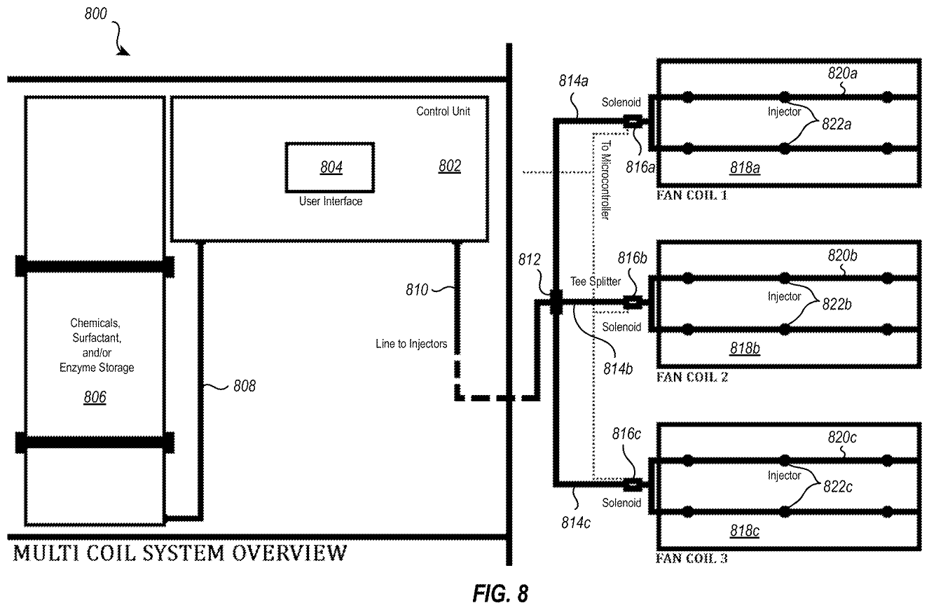

FIG. 8 is a diagram that schematically illustrates an example foam or spray generation and delivery system 800 for automatically generating cleaning foam or maintenance spray and delivering it to a plurality of heat transfer coils (e.g., three, labeled as Fan Coil 1, Fan Coil 2, and Fan Coil 3). The generation and delivery system 800 includes a control unit 802, which can be a computerized system with a user interface 804, processor (not shown), and main memory (not shown). The control unit 802 can incorporate a pump and other apparatus illustrated in FIG. 6 as desired. As in FIG. 6, the control unit 802 can include an air compressor, pump(s), power inputs, and the like.

The control unit 802 is configured to receive desired inputs, such as water and one or more of chemical(s), surfactant or enzymes from one or more storage tanks 806 via input line(s) 808. Water can be supplied by a water input line (not shown). The control unit 802 combines water, and one or more of chemical(s), surfactant or enzymes to produce a desired foam or spray mixture that will be delivered to coil injectors by means of a main delivery line 810. A distribution unit or tee splitter 812 receives the foam or spray mixture from the main delivery line 810 and delivers it via split delivery lines 814a, 814b, 814c to one or more of the coils in a desired sequence. A microcontroller (not shown) selectively operates solenoids 816a, 816b, 816c, which selectively open and close an associated solenoid valve to deliver foam or spray to a selected heat transfer coil 818a, 818b, 818c. The foam or spray can be delivered via one or more sub-delivery lines 820a, 802b, 820c, which then distribute foam or spray to a selected heat transfer coil 818a, 818b, 818c via injectors 822a, 822b, 822c. The order, duration and type of foam or spray delivered to the heat transfer coils 818a, 818b, 818c can be programmed into the control unit 802 and controlled by input via the user interface 804.

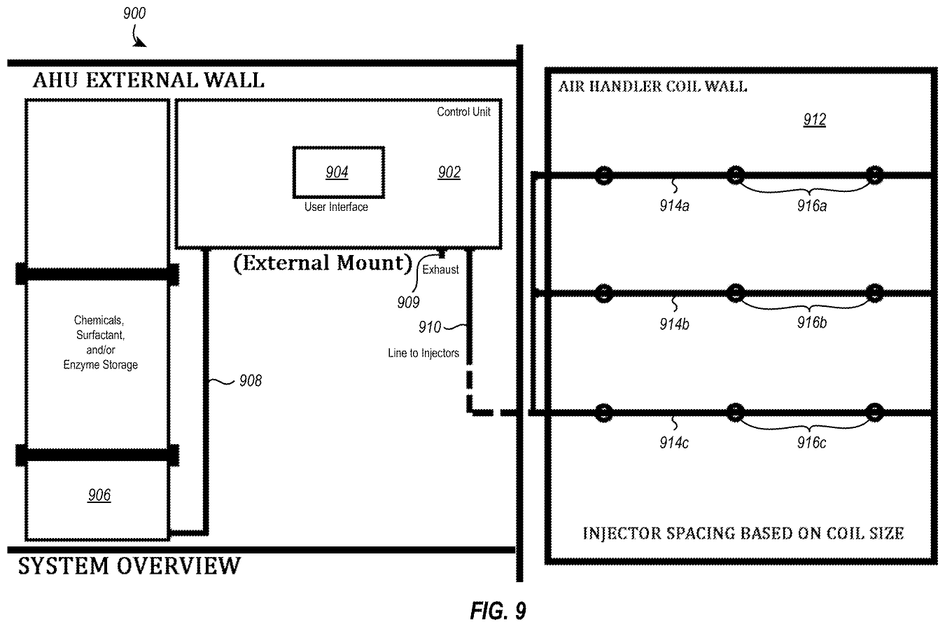

FIG. 9 is a diagram that schematically illustrates an example foam or spray generation and delivery system 900 for automatically generating cleaning foam or maintenance spray and delivering it to an air handler/coil wall 912. The generation and delivery system 900 includes a control unit 902, which can be a computerized system with a user interface 904, processor (not shown), and main memory (not shown). The control unit 902 can incorporate a pump and other apparatus illustrated in FIG. 6 as desired. As in FIG. 6, the control unit 902 can include an air compressor, pump(s), power inputs, and the like.

The control unit 902 is configured to receive desired inputs, such as water and one or more of chemical(s), surfactant or enzymes from one or more storage tanks 906 via input line(s) 908. Water can be supplied by a water input line (not shown). The control unit 902 combines water, and one or more of chemical(s), surfactant or enzymes to produce a desired foam or spray mixture that will be delivered to coil injectors by means of a main delivery line 910. A distribution unit or tee splitter receives the foam or spray mixture from the main delivery line 910 and delivers it via sub-delivery lines 914a, 914b, 914c to the air handler/coil wall 912, which distribute foam or spray to the heat transfer coil 912 via injectors 916a, 916b, 916c. The duration and type of foam or spray delivered to the heat transfer coil 912 can be programmed into the control unit 902 and controlled by input via the user interface 904.

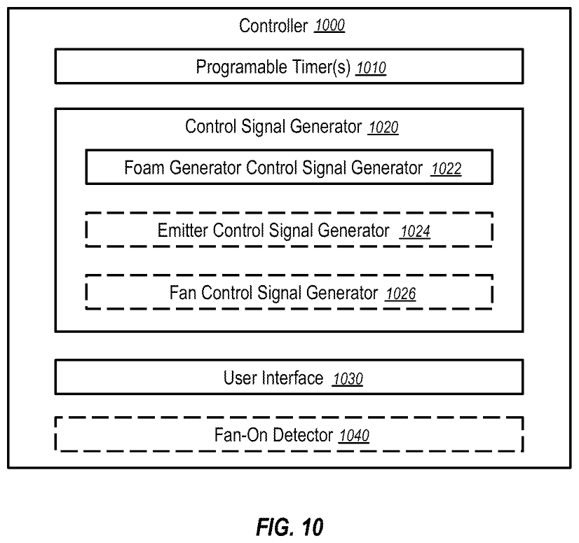

FIG. 10 is a diagram that illustrates an example architecture of a controller 1000, which can be used for any of deep draw HVAC coil systems disclosed herein. The controller 1000 includes one or more programmable timers 1010, a control signal generator 1020, and a user interface 1030. The user interface 1030 is configured to receive a user input to set the one or more programmable timers 1010. The control signal generator 1020 includes a foam or spray generator control signal generator 1022 configured to generate a first control signal to turn on or off a foam or spray generator based on the one or more programmable timers 1010 set by the user input.

In some embodiments, each of one or more emitters of foam or spray (not shown) can include a valve and an electric actuator (not shown) configured to turn on or off a valve based on a second control signal, such that the one or more emitters are turned on or off based on the second control signal. The control signal generator 1020 further includes an emitter control signal generator 1024 configured to generate the second control signal to turn on or off any combination or subset of emitters.

In some embodiments, the controller 1000 also includes a fan-on detector 1040 configured to detect whether the air handler or auxiliary fan (not shown) is running and/or what is the speed of the air handler or auxiliary fan. In response to determining that the air handler or auxiliary fan is running and/or the speed of the air handler or auxiliary fan if running, the control signal generator 1020 then generates the first control signal to turn on the foam or spray generator and/or the second control signal to turn on the emitters.

In some embodiments, the control signal generator 1020 further includes a fan control signal generator 1026 configured to generate a third control signal to turn on the air handler or auxiliary fan. In response to determining that the air handler or auxiliary fan is not on, the fan control signal generator 1026 generates the third control signal to turn on the air handler or auxiliary fan before generating the first control signal to turn on the foam or spray generator and/or the second control signal to turn on the emitters.

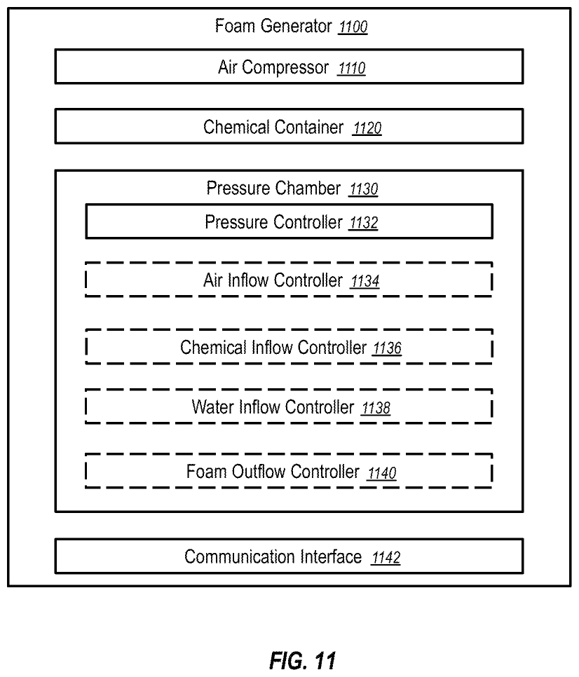

FIG. 11 illustrates an example architecture of a foam or spray generator 1100, which corresponds to foam or spray generators disclosed herein. The foam or spray generator 1100 includes an air compressor 1110, a chemical container 1120, and a pressure chamber 1130. The air compressor 1110 is configured to generate pressurized air. The chemical container 1120 is configured to contain one or more cleaning chemicals, such as (but not limited to) surfactants and enzymes. In some embodiments, the chemical container 1120 is configured to hold one or more solid compounds. In some embodiments, the chemical container 1120 is configured to hold one or more liquid solutions, which can be pumped into a pressure chamber 1130 by an air pump (which may or may not be a part of the air compressor 1110.

The pressure chamber 1130 includes (1) one or more chemical input ports configured to receive the one or more chemicals, (2) an air input port configured to receive the pressurized air, and (3) a water input port configured to receive water. A mixture of the chemical(s), the pressurized air, and the water are configured to form a desired foam or spray. The pressure chamber 1130 also includes one or more outflow ports configured to output the foam or spray into injection ports or other emitters disclosed herein.

In some embodiments, the pressure chamber 1130 further includes a pressure controller 1132 configured to control a pressure therein. In some embodiments, the pressure chamber 1130 further includes an air inflow controller 1134 configured to control an inflow of the pressurized air. In some embodiments, the pressure chamber 1130 further includes a chemical inflow controller 1136 configured to control an inflow of the one or more chemicals. In some embodiments, the pressure chamber 1130 further includes a water inflow controller 1138 configured to control an inflow of the water. Altering the ratio of input components (e.g., the chemical(s), the air, and/or the water) yields different types of cleaning foam or spray, such as thicker foam, thinner foam, richer foam, diluted foam, adherent foam, runny foam, liquid spray, and the like, depending on the needs of the cleaning. In some embodiments, the pressure chamber 930 further includes a foam or spray outflow controller 1140 configured to control an outflow of the foam or spray.

The foam or spray generator 1100 also includes a communication interface 1142 configured to communicate with the controller 1000 (FIG. 10). The communication interface 1142 may include a wired and/or a wireless interface. In some embodiments, the wireless interface is configured to communicate with a mobile device, and a mobile application installed on the mobile device serves as a controller 1000.

The following discussion now refers to a number of methods and method acts or steps that may be performed. Although the method acts or steps may be discussed in a certain order or illustrated in a flow chart as occurring in a particular order, no particular ordering is required unless specifically stated, or required because an act is dependent on another act being completed prior to the act or step being performed.

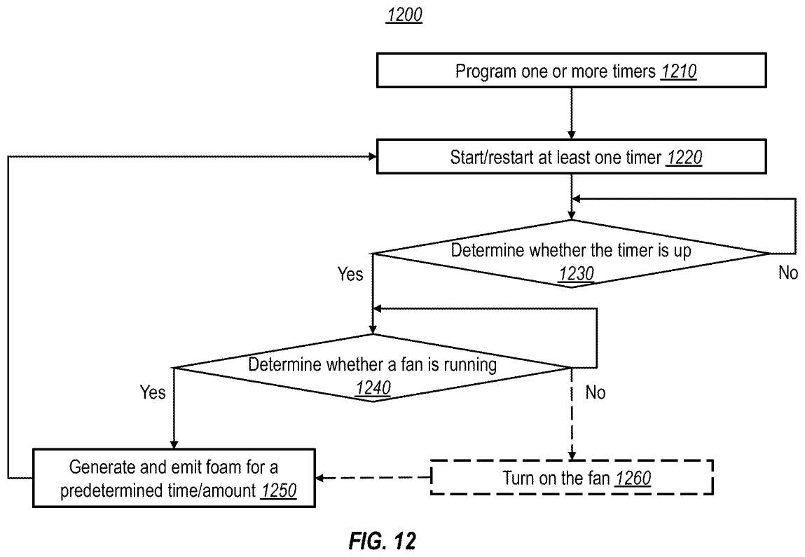

FIG. 12 illustrates a flowchart of an example method 1200 that may be implemented at a controller (e.g., 1000) for controlling a self-cleaning deep draw HVAC coil (e.g., a condenser coil or an evaporator coil). The fan is configured to cause air to flow into a front side of the heat transfer coil and flow out of a back side. The method 1200 includes an act or step 1210 of programming one or more programmable timers and an act or step 1220 of starting at least one of the one or more timers. In response to performing an act or step 1230 of determining that the at least one timer is up, an act or step 1240 is then performed to determine whether the fan is running. In response to the act or step 1240 of determining that the fan is running, the controller causes a foam or spray generator to generate foam or spray, and/or causes one or more emitters to inject the foam or spray to the heat transfer coil for a predetermined time or a predetermined amount (act or step 1250). In some embodiments, in response to determining that the fan is not running, the controller waits until the fan is turned on, then causes the foam or spray generator to generate foam or spray and/or cause the one or more emitters to emit the foam or spray for a predetermined time or a predetermined amount. In some embodiments, in response to determining that the fan is not running, the controller automatically turns the fan on (act or step 1260). As such, the foam or spray is caused to flow through the condenser coil by the airflow generated by the fan. In some cases, movement of air through the coil causes a liquid spray or thin foam to become volumized into more aerated foam.

In some embodiments, different timers are set for emitting different types of foam or spray. For example, a first timer may be set for emitting thick cleaning foam for a first period (e.g., an hour) at a first frequency (e.g., quarterly, semi-annually, or annually), and a second timer may be set for emitting a mist or fog containing enzymes and/or disinfectant for a second period (e.g., one minute) at a second frequency (e.g., daily, weekly, or monthly). In some embodiments, a sequence of operations is programmed to be performed sequentially. In some embodiments, different types of foam or spray are sequentially emitted one after another. For example, thick cleaning foam may first be emitted for a first period of time (e.g. an hour); after that, thin cleaning foam may then be emitted for a second period of time (e.g., half an hour); and after that, a mist containing enzymes or disinfectant (or deodorizer) may then be emitted for a third period of time (e.g., a few minutes).

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A self-cleaning heat transfer coil of an HVAC system comprising:
a deep draw HVAC coil having a depth of at least 18 inches;
a plurality of cooling coils and cooling fins with spaces therebetween that permit air to flow therethrough; and
a plurality of spaced-apart foam or spray emitters, at least one foam or spray emitter being positioned to emit foam or spray at or near a front surface of the deep draw HVAC coil and at least one other foam or spray emitter being positioned to emit foam or spray within an interior region of the deep draw HVAC coil.

2. The self-cleaning heat transfer coil according to claim 1, wherein the deep draw HVAC coil has a depth of at least 24, or at least 36 inches, or at least 48 inches, or at least 60 inches, or at least 72 inches.

3. The self-cleaning heat transfer coil according to claim 1, wherein the plurality of spaced-apart foam or spray emitters are spaced-part at intervals of at least 1 inch, at least 2 inches, at least 4 inches, at least 6 inches, at least 8 inches, at least 10 inches, or at least 12 inches.

4. The self-cleaning heat transfer coil according to claim 1, wherein the plurality of spaced-apart foam or spray emitters are vertically oriented foam or spray emitter coils positioned between cooling coils at predetermined intervals.

5. The self-cleaning heat transfer coil according to claim 1, wherein the plurality of spaced-apart foam or spray emitters are horizontally oriented foam or spray emitter coils positioned above a plurality of cooling coils.

6. The self-cleaning heat transfer coil according to claim 1, wherein the plurality of spaced-apart foam or spray emitters comprise injection ports through a top plate of a housing for the deep draw HVAC coil, with the foam or spray initially flowing through and at least partially filling a gap between the top plate and the cooling coils and fins beneath the top plate and then descending vertically downward between the cooling coils and cooling fins in the absence of air flow and then flowing horizontally through spaces through the coil upon activating air flow through the coil.

7. The self-cleaning heat transfer coil according to claim 1, further comprising a cleaning foam or spray generating system in fluid communication with the deep draw HVAC coil.

8. The self-cleaning heat transfer coil according to claim 7, wherein the cleaning foam or spray generating system is programmable to introduce cleaning foam or spray into the deep draw HVAC coil at predetermined intervals.

9. The self-cleaning heat transfer coil according to claim 8, wherein the cleaning foam or spray generating system is programmable to introduce different types of cleaning foam or spray at predetermined intervals.

10. The self-cleaning heat transfer coil according to claim 1, wherein the self-cleaning heat transfer coil is configured to introduce foam or spray into the coils while operating an air handler, which pushes or pulls air through the coils to assist movement of cleaning foam or spray through spaces in the coils.

11. A method of cleaning a deep draw HVAC coil system, the method comprising:
introducing a cleaning foam or spray into a deep draw HVAC coil system, wherein the deep draw HVAC coil system comprises:
a plurality of heat transfer coils; and
a plurality of foam or spray emitters intermittently disposed among the plurality of heat transfer coils; and
causing or allowing the cleaning foam or spray to pass through the deep draw HVAC coil system, wherein the cleaning foam or spray cleans the deep draw HVAC coil system.

12. The method according to claim 11, wherein the cleaning foam comprises water, enzymes, and/or at least one surfactant.

13. The method according to claim 11, wherein the deep draw HVAC coil has a depth of at least 24, or at least 36 inches, or at least 48 inches, or at least 60 inches, or at least 72 inches.

14. The method according to claim 11, wherein the plurality of foam or spray emitters are configured to emit foam or spray at spaced-part intervals of at least 1 inch, at least 2 inches, at least 4 inches, at least 6 inches, at least 8 inches, at least 10 inches, or at least 12 inches.

15. The method according to claim 11, further comprising sensing when the deep draw HVAC coil is in need of clean and activating a cleaning interval in which the cleaning foam or spray is introduced into the deep draw HVAC coil system, wherein the cleaning foam or spray cleans the deep draw HVAC coil system.

16. A self-cleaning deep draw HVAC coil system, comprising:
a deep draw HVAC coil at least 18 inches in depth;
at least two foam or spray emitter coils configured to emit cleaning foam or spray, at least one foam or spray emitter being positioned to emit foam or spray at or near a front surface of the deep draw HVAC coil and at least one other foam or spray emitter being positioned to emit foam or spray within an interior region of the deep draw HVAC coil; and
a cleaning foam or solution generating system in fluid communication with the at least two foam or spray emitter coils.

17. The self-cleaning deep draw HVAC coil system according to claim 16, further comprising one or more sensors that detect when the deep draw HVAC coil is in need of cleaning and activating an automated coil cleaning system that applies the cleaning foam or spay to the deep draw HVAC coil.

18. The self-cleaning deep draw HVAC coil system according to claim 16, wherein the deep draw HVAC coil has a depth of at least 24, or at least 36 inches, or at least 48 inches, or at least 60 inches, or at least 72 inches.

19. The self-cleaning deep draw HVAC coil system according to claim 16, wherein the foam or spray emitters are configured to emit foam or spray at spaced-part intervals of at least 1 inch, at least 2 inches, at least 4 inches, at least 6 inches, at least 8 inches, at least 10 inches, or at least 12 inches.

20. The self-cleaning deep draw HVAC coil system according to claim 16, wherein the cleaning foam or solution generating system is programmable to introduce cleaning foam or spray into the deep draw HVAC coil at predetermined intervals.
